(19) United States
(12) Patent Application Publication
(10) Pub. No.: US 2006/0209214 A1
(43) Pub. Date: Sep. 21, 2006

(54) Digital photo album systems and methods

(75) Inventors: David A. Fader, Rochester, NY (US); Anthony J. Leone III, Pittsford, NY (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: Xerox Corporation

(21) Appl. No.: 11/082,400

(22) Filed: Mar. 17, 2005

(51) Int. Cl. H04N 9/74

(52) U.S. Cl. 348/584

(57) ABSTRACT

A method and computerized system for producing a digital photo album comprise a graphic user interface having at least one display and tactile device. An image inbox adds, deletes, orders, crops, sizes, and/or rotates images to be included in a digital photo album based on drag-and-drop, or other user input obtained through the display and tactile device. The images are displayed in the image inbox as thumbnails on the display. An auto-population engine automatically positions the images on electronic pages of the digital photo album. The electronic pages are also displayed on the display. An editing engine is used to reposition, further rotate, and/or resize the images, after the images are positioned on the electronic pages by the auto-population engine, based on additional drag-and-drop or other user input obtained through the display and tactile device.

### BACKGROUND

Embodiments herein generally relates to digital photo albums and more particularly to a method and system of creating digital photo problems that provides an image inbox that operates using a drag-and-drop interface to add, remove, order, size, crop, and/or rotate images before the images are auto-populated into the electronic photo album pages.

Modern photography is moving into the digital age. Even though a large part of the market for photography still utilizes conventional film and processing, the ability to obtain digital files from conventional film is rapidly adapting the conventional film market into the digital image arena. In addition, with the broad acceptance of digital cameras, as well as broad utilization of digital images in Internet applications, the volume of commercial and consumer produced digital image files has increased dramatically in recent years. Suppliers now routinely deliver digital image files to users. Such files may be delivered on storage media, like photo CD's and so forth, or may be delivered via the Internet or through e-mail. The provision of digital images in an organized format, including the preparation of digital image photo albums, is now available in the marketplace, as consumers desire to receive and present their images in a most favorable light. However, there has yet to be introduced an automated system that presents digital images in sophisticated creatively composed fashions.

There are a number of commercially available digital imaging systems that allow a customer to personalize a reprint or enlargement of an image from a scanned photograph, negative, slide, digital camera, or other source or create a digital photo album from the images. This personalization can be performed by adding text, by adding decorative borders, and by similar operations that enhance the original image. Digital imaging systems that allow a customer to participate in personalizing a reprint include the KODAK Picture Maker system, manufactured by Eastman Kodak Company, Rochester, N.Y., the Fuji Aladdin system, manufactured by Fuji Photofilm, Japan, and the Photo Ditto System, manufactured by Pixel Magic Imaging, Inc., San Marcos, Tex. As standard components, these systems include a print scanner, a control console (typically a touchscreen monitor) for operator commands interface, a computer for image processing, and an output printer. These systems can be installed on a store countertop, where an operator (typically, a retail clerk) scans a customer photograph and, with the customer looking on, adds text or other image personalization. Or, these systems can be installed within a cabinet or kiosk for self-serve operation, where a retail clerk assists the customer as necessary.

Systems such as the Picture Maker, Aladdin, and Photo Ditto systems are intended to provide reprints or enhanced reprints of photographs that can be used in digital photo albums. Such systems can be seen as a substitute for standard, silver-halide-based reprinting of photographs, with some enhancements. The enhancements provided by these systems may optionally place the photographic reprint within a graphic border, place text on a portion of the photographic image, or arrange reprint images within a fixed graphic layout.

There presently exist several software applications, which assist the user in manual creation of digital photo albums. In general, these applications provide the user with a straightforward means of accomplishing the basic task of image organization and page layout, so called ‘albuming’. The drawback with such applications is that they either require a large amount of user interaction, or they severely limit the amount of input the user is allowed to have with respect to the layout and positioning of the images within the digital photo album. Therefore, with existing products, the user is left with the choice of either performing an extensive amount of work in the layout and organization of the photo album or of selecting between a very limited number of generic templates.

### SUMMARY

To address these and other issues, disclosed herein is a method and computerized system for producing a digital photo album. The system comprises a graphic user interface comprising at least one display and tactile device. An image inbox adds, deletes, orders, crops, sizes, and/or rotates images to be included in a digital photo album based on drag-and-drop, click-and-rotate, or other user input obtained through the display and tactile device. The images are displayed in the image inbox as thumbnails on the display. An auto-population engine automatically positions the images on electronic pages of the digital photo album. The electronic pages are also displayed on the display. An editing engine is used to reposition, further rotate, crop, and/or resize the images, after the images are positioned on the electronic pages by the auto-population engine, based on additional drag-and-drop and click-and-rotate user input obtained through the display and tactile device.

The order and rotation of the images is maintained as metadata for an instance of the image inbox. The image inbox can also be used to add text annotations to the digital photo album based on the user input. Alternatively, the auto-population engine can automatically add text annotations to the digital photo album based on metadata associated with the images.

The auto-population engine receives user input concerning (and bases the automatic image positioning on) the number of images per page, the desired layout of images on the electronic pages, the total number of pages for the digital photo album, and/or the desired size of the images on the electronic pages. For example, the auto-population engine is adapted to receive user input for selection of a predefined layout template from a plurality of predefined layout templates.

These and other features are described in, or are apparent from, the following detailed description.

### BRIEF DESCRIPTION OF THE DRAWINGS

Various exemplary embodiments of the systems and methods described in detail below, with reference to the attached drawing figures, in which:

FIG. 1 is a schematic representation of a system embodiment;

FIG. 2 is a schematic representation of a screenshot of an image inbox;

FIG. 3 is a schematic representation of a screenshot of an electronic photo album page; and

FIG. 4 is a flow chart illustrating a method embodiment.

### DETAILED DESCRIPTION

As mentioned above, with existing digital photo album products, the user is left with the choice of either performing an extensive amount of work in the layout and organization of the photo album, or of selecting between a very limited number of generic templates, with little chance for deviation from the generic templates. One advance presented by the embodiments described herein is the utilization of an image inbox that permits not only the selection of which images will be included within the digital photo album (through routine addition and removal operations) but also permits resizing, cropping, rotating, reordering, etc. of the images within the image inbox prior to the images being auto-populated into the photo album. In addition, after the images are auto-populated, the user is provided with an editing engine that allows selected post-assembly editing of the final album prior to printing or transmitting the finalized photo album. Therefore, by simply making minor adjustments to the images as they are placed into the inbox, the user is provided with a quick and simple opportunity to significantly improve the product that is created by the auto-population engine. In addition, the final editing engine provides even more flexibility for the user to make minor (or major) revisions to the photo album so as to finalize the photo album into a high-quality product, without having to expend significant time or effort.

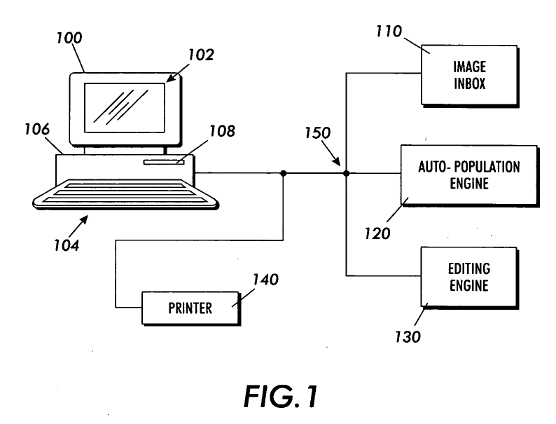

Thus, embodiments herein include a method and computerized system for producing a digital photo album. As shown in FIG. 1, the system comprises a graphic user interface 100 comprising at least one display 102, tactile device 104, and central processing unit (CPU) 106. The graphic user interface 100 can comprise any type of user interaction device including a desktop or mainframe computer, portable digital assistant (PDA), cell phone, camera, printer, kiosk, copier, scanner, tool, as well as any other similar type of device which can receive input from users, whether currently known or developed in the future. The display 102 can comprise any form of display including cathode ray tube (CRT), liquid crystal display (LCD), plasma display, projector display, light emitting diode (LED) display, and other similar types of devices which have the ability to visually display items, whether now known or developed in the future. Similarly, the tactile device 104 can comprise a keyboard, touchscreen, mouse, trackball, keypad, touchbar, number pad, operational buttons, voice activation receiver, or any other form of device that can receive input from users, whether currently known or developed in the future. Similar hardware is discussed in U.S. Pat. No. 6,657,702, the complete disclosure of which is incorporated herein by reference.

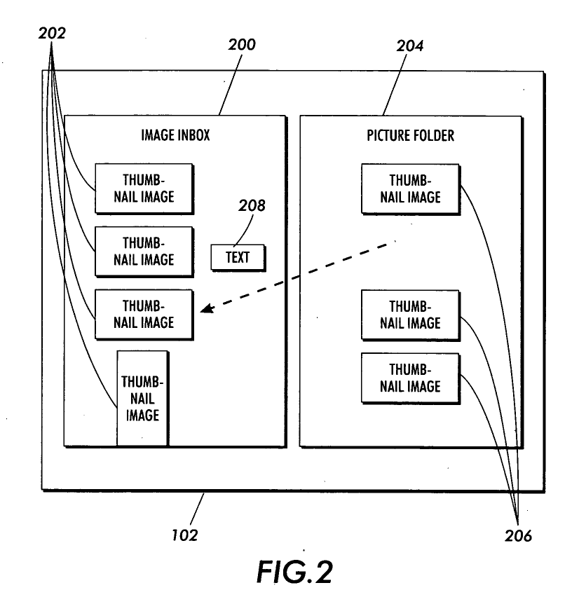

FIG. 1 also illustrates an image inbox 110. While the image inbox 110 is illustrated as a separate item connected to the CPU 106 via a network 150, as would be understood by one ordinarily skilled in the art given this disclosure, the image inbox could be included within the CPU 106 as either a separate device or as a separate functional software module or program that is stored within the internal storage of the CPU 106. The image inbox 110 causes the display 102 to display a graphic representation of the image inbox 110, as shown in FIG. 2.

More specifically, as shown in FIG. 2, the image inbox 110 generates an image inbox representation 200 on the display 102. The image inbox 110 adds, deletes, orders, crops, resizes, and/or rotates images to be included in a digital photo album based on drag-and-drop, or other user input obtained through the display 102 and tactile device 104. Therefore, as shown in FIG. 2, previously stored pictures that are located within a picture folder 204 (or other similar storage) and are represented on the display 102 as thumbnail images 206 can be moved or copied to the image inbox 200 as shown by the dashed arrow in FIG. 2. Within the image inbox graphical representation 200, the thumbnail images 202 are positioned within a specific order and can be optionally rotated in any degree of rotation as shown by the bottom thumbnail image in FIG. 2. The images are also displayed in the image inbox 110 as thumbnails on the display 102.

The thumbnail images 206 can be moved or copied from the picture folder using any of a number of user inputs and these inputs are referred to herein, as drag-and-drop and/or drag-and-rotate inputs. More specifically, as used herein, drag-and-drop and other inputs include a single or double click (and/or click and hold, voice command, etc.) on the tactile device 104 such as a mouse, trackball, touchpad, touchscreen etc. (or other tactile device 104 operation to highlight a selected thumbnail image 206) combined with movement of the tactile device 104 features (either through actual movement along the touchscreen or touchpad, movement of the mouse or trackball, keypad/keyboard input, voice command, etc.) followed by a releasing action which can comprise a click, double click, release of the tactile device 104, voice command, etc. when the thumbnail image 202 is in the proper order position within the graphic representation of the image inbox 200.

Alternatively, the concepts of drag-and-drop and other inputs are intended herein, to include any form of selection, such as use of the simple use of a pointer, tab, touchscreen, etc. alone, or in combination with another buttons, such as an enter key, rotate key, and add key, remove key, size change key, crop key, order key, etc. Similarly, any of the thumbnails can be rotated (in either 90 degree increments, other increments, or using non-incremental rotation) by performing any of the foregoing drag-and-drop actions while the cursor is placed over a feature (e.g. a corner or edge) of a thumbnail image. Similarly, the image can be cropped, resize, etc. using similar inputs. The foregoing description is merely an example of the drag-and-drop and other inputs can be used with embodiments herein, and one ordinarily skilled in the art would understand that many other types of actions and interactions with tactile devices are included within the meaning of the terms drag-and-drop and other used herein. For example, U.S. Pat. No. 6,590,586 discusses fundamental concepts relating to drag-and-drop operations of thumbnail images, and the full disclosure thereof is incorporated herein by reference.

The order, rotation, size, cropping, etc. of the images is maintained as metadata for an instance of the image inbox 110 in, for example, the memory of the CPU 106 or within the memory of the image inbox 110. The image inbox 110 can also be used to add text annotations to the digital photo album based on the user input as shown by text box 208. The text box 208 is operated, for example, by the user placing the cursor within the text box and then typing in the text through one of the tactile devices 104. For example, US patent application 2002/0122067 (incorporated herein by reference) discloses methods for adding text directly to photo albums and the entire disclosure thereof is incorporated herein by reference. Alternatively, the auto-population engine 120 can automatically add text annotations to the digital photo album based on metadata associated with the images (such as date, time, event, or any other data that was saved with the images).

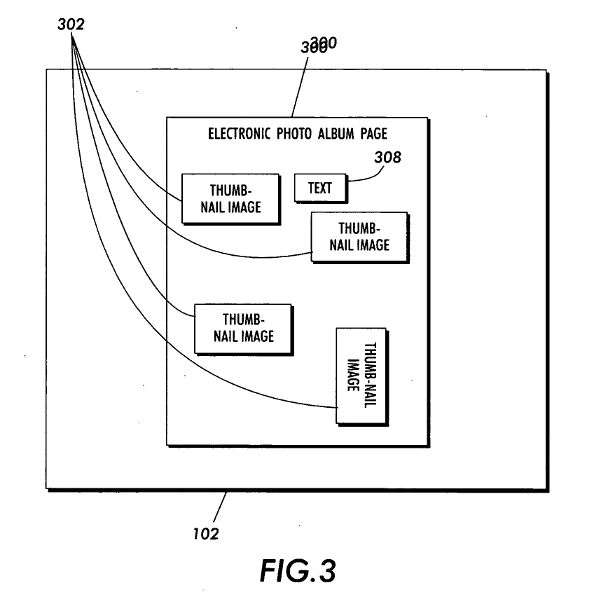

Referring again to FIG. 1, an auto-population engine 120 automatically positions the images 202 that are placed within the image inbox 200 onto electronic pages of the digital photo album in the order and rotational orientation that the thumbnail images 202 are placed in the image inbox 200 by the user. Again, while the auto-population engine 120 is illustrated as a separate item connected to the CPU 106 via a network 150, as would be understood by one ordinarily skilled in the art given this disclosure, the auto-population engine 120 could be included within the CPU 106 as either a separate device or as a separate functional software module or program that is stored within the internal storage of the CPU 106. The electronic pages are also displayed on the display 102. For example, FIG. 3 illustrates an electronic photo album page 300 that includes thumbnail images 302 on the display 102. Item 308 represents the text annotations added by the user or by the auto-population engine 120.

The auto-population engine 120 can receive extensive input regarding how the images and text annotations should be auto-populated upon the electronic photo album page 300. For example, user input can include the user-desired number of images per page, the user-desired layout of images on the electronic pages, the user-desired total number of pages for the digital photo album, and/or the user-desired size of the images on the electronic pages, as well as other similar information. Then, the auto-population engine bases the automatic image positioning on the factors provided by the user using, for example, the processes described in U.S. Patent Pub. 2002/0122067 (incorporated herein by reference). The auto-population engine 120 can also include a number of predefined layout templates from which the user can choose. There are existing document templates that incorporate image processing commands and instructions. U.S. Pat. No. 5,485,568 (incorporated herein by reference) discloses use of a structured image document template that includes built-in IPOs (image processing operations) including image transformers, filters, colorizers, and masks. This arrangement solves the problem of providing a set of well-defined image modification operations that can be readily automated in order to suit the needs of a specific aesthetic design.

Therefore, the auto-population engine 120 is adapted to receive user input for selection of one predefined layout template from the plurality of predefined layout templates. The details of auto-population engines and templates are illustrated in U.S. Pat. Nos. 6,665,587, and 6,704,120 the complete disclosures of which are incorporated herein by reference.

While the placement of the images and the text annotations may be acceptable for many of the electronic photo album pages, there may be situations where the user desires to change the look of one or more of the electronic pages. Therefore, embodiments herein provided an editing engine 130 that can be used to reposition, further rotate, crop, and/or resize, etc. the images, after the images are positioned on the electronic pages by the auto-population engine 120. While the editing engine 130 is illustrated as a separate item connected to the CPU 106 via a network 150, as would be understood by one ordinarily skilled in the art given this disclosure, the editing engine 130 could be included within the CPU 106 as either a separate device or as a separate functional software module or program that is stored within the internal storage of the CPU 106. Again, this resizing, rotating, repositioning, cropping can be accomplished using additional drag-and-drop and click-and-rotate user input obtained through the display 102 and tactile device 104.

Finally, when the photo album is complete, it can be printed on a printer 140, saved on a transportable storage device 108, or sent to another device over the network 150. Note that the network 150 can comprise any type of wired or wireless network, such as a local area network (LAN) such as an intranet or any type of wide area network (WAN) such as the Internet.

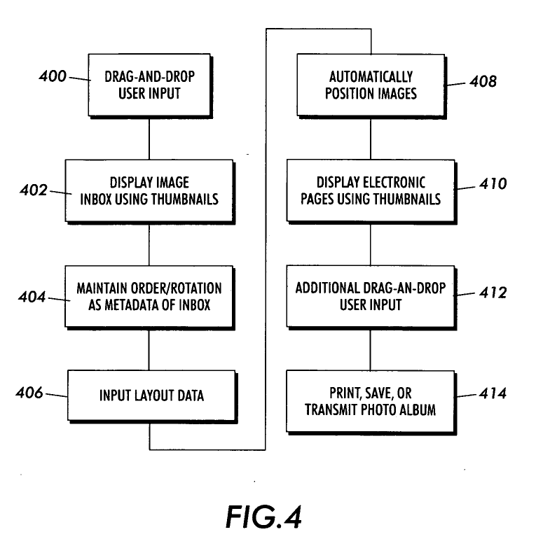

FIG. 4 is a flow chart illustrating a method embodiment of providing a digital photo album. More specifically, in item 400 the user supplies drag-and-drop and click-and-rotate user input to the computerized image inbox to add, remove, size, order, drop, and/or rotate images and text annotations to be included in the digital photo album. The image inbox displays the images as thumbnails on the display in item 402. The order and rotation of the images is maintained as metadata for an instance of the image inbox in item 404. Next, the user inputs layout data, such as selecting one of the predetermined layout formats or by defining the number of images per page, the size of the images, the number of total pages, etc. in item 406.

In item 408, the images are automatically positioned on the electronic pages of the digital photo album using the auto-population engine. This allows the electronic pages to be displayed, again using thumbnails (item 410). The user then is given the opportunity to supply additional drag-and-drop and click-and-rotate user input to the editing engine to reposition, rotate, and/or resize the images after the images are positioned on the electronic pages by the auto-population engine in item 412. Finally, once the photo album is acceptable to the user, the user can print, save, and/or transmit, etc. the photo album, as shown in item 414.

Thus, as shown above, embodiments herein utilize an image inbox that permits not only the selection of which images will be included within the digital photo album (through routine addition and removal operations) but also permits resizing, cropping, rotating, reordering, etc. of the images within the image inbox prior to the images being auto-populated into the photo album. In addition, after the images are auto-populated, the user is provided with an editing engine that allows selected post-assembly editing of the final album prior to printing or transmitting the finalized photo album. Therefore, by simply making minor adjustments to the images as they are placed into the inbox, the user is provided the with a quick and simple opportunity to significantly improve the product that is created by the auto-population engine. In addition, the final editing engine provides even more flexibility for the user to make minor (or major) revisions to the photo album so as to finalize the photo album into a high-quality product, without having to expand significant time or effort.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A computerized system comprising:
an image inbox adapted to at least one of size, crop, and rotate images to be included in a digital photo album based on user input;
an auto-population engine adapted to automatically position said images on electronic pages of said digital photo album; and
an editing engine adapted to at least one of reposition, rotate, crop and resize said images after said images are positioned on said electronic pages by said auto-population engine, based on additional user input.

2. The system in claim 1, wherein order and rotation of said images is maintained as metadata for an instance of said image inbox.

3. The system in claim 1, wherein said image inbox is further adapted to at least one of add and remove images to be included in said digital photo album based on said user input.

4. The system in claim 1, wherein said image inbox is further adapted to add text annotations to said digital photo album based on said user input.

5. The system in claim 1, wherein said auto-population engine is further adapted to receive user input of, and base automatic image positioning on, at least one of:
a number of images per page;
a layout of images on said electronic pages;
a total number of pages for said digital photo album; and
a size of said images on said electronic pages.

6. The system in claim 1, wherein said auto-population engine is further adapted to receive user input for selection of a predefined layout template from a plurality of predefined layout templates.

7. The system in claim 1, wherein said auto-population engine is further adapted to automatically add text annotations to said digital photo album based on metadata associated with said images.

8. A computerized system comprising:
a graphic user interface comprising at least one display and tactile device;
an image inbox adapted to at least one of size, crop, and rotate images to be included in a digital photo album based on drag-and-drop user input obtained through said graphic user interface, wherein said images are displayed in said image inbox as thumbnails on said graphic user interface;
an auto-population engine adapted to automatically position said images on electronic pages of said digital photo album, wherein said electronic pages are displayed on said graphic user interface; and
an editing engine adapted to at least one of reposition, rotate, crop, and resize said images after said images are positioned on said electronic pages by said auto-population engine based on additional drag-and-drop user input obtained through said graphic user interface.

9. The system in claim 8, wherein order and rotation of said images is maintained as metadata for an instance of said image inbox.

10. The system in claim 8, wherein said image inbox is further adapted to at least one of add and remove images to be included in said digital photo album based on said user input.

11. The system in claim 8, wherein said image inbox is further adapted to add text annotations to said digital photo album based on said user input.

12. The system in claim 8, wherein said auto-population engine is further adapted to receive user input of, and base automatic image positioning on, at least one of:
a number of images per page;
a layout of images on said electronic pages;
a total number of pages for said digital photo album; and
a size of said images on said electronic pages.

13. The system in claim 8, wherein said auto-population engine is further adapted to receive user input for selection of a predefined layout template from a plurality of predefined layout templates.

14. The system in claim 8, wherein said auto-population engine is further adapted to automatically add text annotations to said digital photo album based on metadata associated with said images.

15. A method comprising:
supplying user input to a computerized image inbox to at least one of size, crop, and rotate images to be included in a digital photo album;
automatically positioning said images on electronic pages of said digital photo album using an auto-population engine; and
supplying additional user input to an editing engine to at least one of reposition, rotate, crop and resize said images after said images are positioned on said electronic pages by said auto-population engine.

16. The method in claim 15, further comprising, during said supplying of said user input to said image inbox, maintaining order and rotation of said images as metadata for an instance of said image inbox.

17. The method in claim 15, further comprising at least one of adding and removing images to be included in said digital photo album based on said user input.

18. The method in claim 15, further comprising adding text annotations to said digital photo album based on said user input.

19. The method in claim 15, further comprising receiving, and basing said automatically positioning of said images on, at least one of:
a number of images per page;
a layout of images on said electronic pages;
a total number of pages for said digital photo album; and
a size of said images on said electronic pages.

20. The method in claim 15, further comprising supplying, to said auto-population engine, user input for selection of a predefined layout template from a plurality of predefined layout templates.

21. The method in claim 15, further comprising automatically adding text annotations to said digital photo album based on metadata associated with said images, using said auto-population engine.

22. A method comprising:
supplying drag-and-drop user input to a computerized image inbox to at least one of size, crop, and rotate images to be included in a digital photo album using at least one display and tactile device;
displaying said images in said image inbox as thumbnails on said graphic user interface;
automatically positioning said images on electronic pages of said digital photo album using an auto-population engine;
displaying said electronic pages on said graphic user interface; and
supplying additional drag-and-drop user input to an editing engine through said graphic user interface, to at least one of reposition, rotate, crop, and resize said images after said images are positioned on said electronic pages by said auto-population engine.

23. The method in claim 22, further comprising, during said supplying of said user input to said image inbox, maintaining order and rotation of said images as metadata for an instance of said image inbox.

24. The method in claim 22, further comprising at least one of adding and removing images to be included in said digital photo album based on said user input.

25. The method in claim 22, further comprising adding text annotations to said digital photo album based on said user input.

26. The method in claim 22, further comprising receiving, and basing said automatically positioning of said images on, at least one of:
a number of images per page;
a layout of images on said electronic pages;
a total number of pages for said digital photo album; and
a size of said images on said electronic pages.

27. The method in claim 22, further comprising supplying, to said auto-population engine, user input for selection of a predefined layout template from a plurality of predefined layout templates.

28. The method in claim 22, further comprising automatically adding text annotations to said digital photo album based on metadata associated with said images, using said auto-population engine.
